(19) United States
(12) Patent Application Publication
(10) Pub. No.: US 2023/0294187 A1
(43) Pub. Date: Sep. 21, 2023

(54) METHOD FOR GRINDING OF BEVEL GEARS

(71) Applicant: Klingelnberg GmbH, Huckeswagen (DE)

(72) Inventor: Rolf Schalaster, Wermelskirchen (DE)

(21) Appl. No.: 18/072,293

(22) Filed: Nov. 30, 2022

(30) Foreign Application Priority Data
Dec. 3, 2021 (DE) 10 2021 131 998.6

(51) Int. Cl. B23F 5/06; B23F 21/02; B23F 19/00

(52) U.S. Cl. CPC B23F 5/06; B23F 21/023; B23F 19/005

(57) ABSTRACT

A method includes the following method steps: grinding of bevel gears, wherein the respective bevel gears have a straight toothing to be ground, wherein the grinding is carried out by a disk-shaped grinding tool by discontinuous generating grinding using a predetermined rolling ratio. A cutting face of the grinding tool, which rolls during the grinding with teeth of the straight toothing of a respective bevel gear, forms a section of a hollow cone inner surface, and wherein a respective longitudinal crowning is generated on the respective straight toothing of the respective bevel gears by the grinding using the cutting face forming the section of the hollow cone inner surface. The method is distinguished in that the grinding tool is a dressable grinding tool and dressing of the grinding tool is carried out.

### CROSS-REFERENCE TO RELATED APPLICATIONS

This application is related to and claims the benefit of German Patent Application No. 10 2021 131 998.6, filed on Dec. 3, 2021, the contents of which are herein incorporated by reference in their entirety.

### TECHNICAL FIELD

The present disclosure relates to a method for grinding bevel gears, wherein the respective bevel gears have a straight toothing to be ground, wherein the grinding is carried out by means of a disk-shaped grinding tool by discontinuous generating grinding at a predetermined rolling ratio, wherein a cutting face of the grinding tool, which rolls during the grinding with teeth of the straight toothing of a respective bevel gear, forms a section of a hollow cone inner surface, and wherein a respective longitudinal crowning on the respective straight toothing of the respective bevel gears is generated by the grinding by means of the cutting face forming the section of the hollow cone inner surface.

### BACKGROUND

To make gear wheels of a gearwheel pair as robust as possible with respect to relative displacements in operation, which can occur, for example, as a result of operating loads or due to tolerances of adjacent parts, such as bearings, shafts, housing parts, or the like, the flank topography of gear wheels is modified. These modifications of the tooth flanks are intended deviations from the theoretically exact tooth flank geometry.

Typical toothing modifications are, for example, longitudinal crowning, which is also referred to as width crowning, profile crowning, which is also referred to as height crowning, profile angle modification, bevel angle or spiral angle modification, twist or interleaving, tip relief and base relief.

Straight-toothed bevel gears, which have a longitudinal crowning, can be generated using a disk-shaped tool in the discontinuous rolling method. The radius of the tool can be selected to be very large in relation to the tooth width here, so that only a minor deviation of the tooth root base from a straight line results. To generate the longitudinal crowning on a straight-toothed bevel gear, the cutting face and the disk-shaped tool can be arranged inclined by a hollow cone angle in relation to the workpiece, so that the cutting face forms a section of a hollow cone inner surface.

FIG. 1A and FIG. 1B show the prior art for discontinuous generating grinding for a circular grinding tool 1 in a perspective illustration, the cutting face 3 of which is not inclined or does not have a hollow cone. If a tooth 5 of a straight toothing to be ground is machined using such a grinding tool 1 by discontinuous generating grinding, linear flank lines 9 are generated on a tooth flank 7 of the tooth 5, since a line contact between the grinding tool 1 and the tooth flank 7 is a straight line for every rolling position, wherein FIG. 1B shows the contact in an exemplary and schematic manner for a single flank line 9 for a rolling position. The tooth flank 7 therefore has no longitudinal crowning.

FIG. 2A and FIG. 2B show the prior art for discontinuous generating grinding for a circular grinding tool 11 in a perspective illustration, the grinding surface 13 of which is inclined or has a hollow cone, as schematically indicated by the angle 21. If a tooth 15 of a straight toothing to be ground is machined using such a grinding tool 11 by discontinuous generating grinding, curved, longitudinally-crowned flank lines 19 are generated on a tooth flank 17 of the tooth 15, since a line contact between the grinding tool 11 and the tooth flank 17 is a section of an ellipse for every rolling position, wherein FIG. 2B shows the contact in an exemplary and schematic manner for a single flank line 19 for a rolling position. The tooth flank 17 therefore has longitudinal crowning.

Straight-toothed bevel gears having longitudinal crowning are typically ground using non-dressable CBN tools. Non-dressable CBN tools have, for example, a main body made of steel, which is covered using CBN crystals. The abbreviation CBN is derived from the English term “cubic boron nitride”, in German “kubisches Bornitrid”.

In the scope of the machining of bevel gears by means of a non-dressable CBN tool, each bevel gear of a series to be manufactured is always machined using the same tool geometry and process kinematics, since the diameter or the overall geometry of the non-dressable CBN tool does not change in comparison to dressable tools during the machining of the series of bevel gears to be manufactured, because no dressing procedures take place. The straight-toothed bevel gears produced using such a non-dressable CBN tool therefore always have the same final geometry.

A longitudinal crowning may be produced on a straight-toothed bevel gear by means of a non-dressable CBN tool in the above-described manner, in which a cutting face is provided with a hollow cone angle (cf. FIG. 2A and FIG. 2B). All straight-toothed bevel gears of a series have the same longitudinal crowning and the same radius of curvature in the gap base here. Such non-dressable CBN tools are very high-performance, but are costly to produce and are not flexibly usable. A new non-dressable CBN tool thus has to be produced if, for example, a height crowning is to be generated, which deviates from the height crowning available on the previously used non-dressable CBN tool.

Against this background, the disclosure is based on the technical problem of specifying a method which enables more cost-effective production of straight-toothed bevel gears having a longitudinal crowning.

### SUMMARY

The above-described technical problem is solved by a method as claimed in the independent claim. Further embodiments of the disclosure result from the dependent claims and the following description.

According to the disclosure, a method is specified having the following method steps: grinding of bevel gears, wherein the respective bevel gears have a straight toothing to be ground, wherein the grinding is carried out by means of a disk-shaped grinding tool by discontinuous generating grinding at a predetermined rolling ratio, wherein a cutting face of the grinding tool, which rolls during the grinding with teeth of the straight toothing of a respective bevel gear, forms a section of a hollow cone inner surface, and wherein a respective longitudinal crowning on the respective straight toothing of the respective bevel gears is generated by the grinding by means of the cutting face forming the section of the hollow cone inner surface. The method is distinguished in that the grinding tool is a dressable grinding tool and dressing of the grinding tool takes place.

Studies of the applicant have shown that straight-toothed bevel gears having a longitudinal crowning may also be produced in satisfactory quality using a dressable grinding tool, instead of using non-dressable CBN tools, in the discontinuous rolling method. According to the disclosure, straight-toothed bevel gears having a longitudinal crowning can therefore be produced in an efficient and cost-effective manner using a dressable grinding tool.

When reference is made in the present case to discontinuous generating grinding, this refers here to a grinding method in which the individual teeth of a respective bevel gear are machined in succession. In contrast to the profile grinding known from the straight gear field, in which the profile shape of the grinding tool maps the shape of the tooth gap to be generated and which is also a discontinuous method, in discontinuous generating grinding, the tooth shape or the tooth flank is generated by a coupled rolling movement between the grinding tool and the workpiece, the bevel gear here.

When reference is made in the present case to a dressable grinding tool, this refers here, for example, to a ceramic bonded grinding tool. Alternatively, the dressable grinding tool can be, for example, a tool having artificial resin bonding. The dressable grinding tool can comprise, for example, one or more of the following abrasive grit materials: quartz, corundum, emery, garnet, diamond, cubic boron nitride (CBN), or silicon carbide.

According to the disclosure, it is provided that at least one first bevel gear of the bevel gears is ground before the dressing by means of the dressable grinding tool and at least one second bevel gear of the bevel gears is ground after the dressing by means of the dressable grinding tool, wherein during the dressing of the dressable grinding tool, a radius of the grinding tool is reduced by the dressing from a first radius to a second radius, wherein the cutting face of the grinding tool forming the section of the hollow cone inner surface is inclined before the dressing by a first hollow cone angle and is inclined after the dressing by a second hollow cone angle, wherein a radius of curvature of the longitudinal crowning is constant before and after the dressing, and wherein the following applies:

$${γ}_{2} = arc sin ( \frac{{r}_{02}}{{r}_{01}} \cdot sin {γ}_{1} ) ;$$

with r₀₁ as the first radius of the grinding tool, with r₀₂ as the second radius of the grinding tool, with γ₁ as the first hollow cone angle, and with γ₂ as the second hollow cone angle.

Because the radius of curvature of the longitudinal crowning is specified as constant before and after the dressing, the hollow cone angle is adapted to the reduced radius of the grinding tool.

It can be provided that the absolute value of a longitudinal crowning of the straight toothing of the first bevel gear generated by the grinding corresponds to the absolute value of a longitudinal crowning of the straight toothing of the second bevel gear generated by the grinding.

When reference is made in the present case to a longitudinal crowning, this refers here to a deviation of a flank line from a linear, non-longitudinally-crowned flank line, in particular at the level of the pitch cone of the bevel gear, wherein the absolute value of such a longitudinal crowning corresponds to the maximum distance of the curved flank line from this linear, non-longitudinally-crowned flank line in the region of the toe or heel of a tooth of a straight toothing of a respective bevel gear at the level of the pitch cone.

According to one embodiment of the method, it can be provided that a radius of curvature in a gap base of the straight toothing of the first bevel gear is greater than a radius of curvature in a gap base of the straight toothing of the second bevel gear. Studies of the applicant have shown that the straight-toothed bevel gears produced according to the above-explained embodiment of the method, in spite of a radius of curvature changing after the dressing in the gap base of the straight toothing, meet all requirements for the usage behavior and in particular the load capacity. Insofar as a longitudinal crowning remaining uniform with respect to the absolute value is to be generated on the straight-toothed bevel gears to be produced both before and after the dressing, a changing radius of curvature in the gap base does not have to be balanced out by complex machine kinematics, such as pendulum movements or the like, but can remain unchanged on the second bevel gear.

It can be provided that the shape of the longitudinal crowning of the first bevel gear deviates from the shape of the longitudinal crowning of the second bevel gear. I.e., although the same absolute value of the longitudinal crowning is generated on the tooth flanks before and after the dressing, the shape of a respective generated flank line can deviate before and after the dressing, wherein the flank lines before and after the dressing deviate from one another by less than 3 micrometers or by less than 1 micrometer. A point of the rotating grinding tool moves on an elliptical path relative to the tooth flank to be generated due to the hollow cone angle. Due to the dressing, the radius of the grinding tool thus changed, and the changed hollow cone angle, a different elliptical path results for the relative movement after the dressing, which can deviate, for example, by less than 2 micrometers or by less than 1 micrometer from the elliptical path before the dressing. However, the same longitudinal crowning is qualitatively generated on the teeth of the bevel gear, which would also be generated using non-dressable tools. Before and after the dressing, longitudinal crownings having uniform quality can therefore be manufactured by means of the dressable grinding tool.

It can be provided that a tool flank angle of the grinding tool is adapted by the dressing and/or the predetermined rolling ratio between the grinding tool and the second bevel gear is adapted after the dressing, wherein before and after the dressing, the same engagement angle of the bevel gear toothing on the first and second bevel gear is generated.

It can be provided that the tool flank angle of the grinding tool is adapted by the dressing by the difference of the first angle of inclination to the second angle of inclination, wherein before and after the dressing, the same engagement angle of the bevel gear toothing is generated on the first and second bevel gear. In particular the rolling ratio can remain the same before and after the dressing here.

According to one embodiment of the method, it can be provided that right flanks of the respective straight toothing of a respective bevel gear are machined in a first infeed using first machine settings and left flanks of the respective straight toothing of a respective bevel gear are machined in a second infeed using second machine settings. In particular, the machine settings for the right and left flanks can be “mirrored”.

It can be provided that the radius of the tool corresponds to at least three times, at least five times, or at least ten times a tooth width of the teeth of the bevel gear.

Preferably, no relative stroke movement takes place along a tooth width between the bevel gear and the grinding tool. In particular, no pendulum stroke is executed.

### BRIEF DESCRIPTION OF THE DRAWINGS

The disclosure is described in more detail hereinafter on the basis of a drawing illustrating exemplary embodiments. In the respective schematic figures:

FIG. 1A shows a tooth of a straight toothing and a grinding tool without inner hollow cone;

FIG. 1B shows the generation of a linear flank line without longitudinal crowning on the tooth according to FIG. 1A using the grinding tool according to FIG. 1A;

FIG. 2A shows a tooth of a straight toothing and a grinding tool with inner hollow cone;

FIG. 2B shows the generation of a flank line with longitudinal crowning on the tooth according to FIG. 2A using the grinding tool according to FIG. 2A;

FIG. 3 shows a straight-toothed bevel gear in a sectional illustration with a detail of a disk-shaped grinding tool;

FIG. 4 shows the bevel gear and the grinding tool from FIG. 3 in a further sectional illustration;

FIG. 5 shows a longitudinal crowning of a tooth;

FIG. 6 shows the arrangement from FIG. 4 with indicated hollow cone angle and radius of curvature of the longitudinal crowning;

FIG. 7 shows the ratio of the tool radius to the hollow cone angle at predetermined radius of curvature of the longitudinal crowning;

FIG. 8 shows a first bevel gear and the grinding tool before dressing of the grinding tool;

FIG. 9 shows a second bevel gear and the grinding tool after dressing of the grinding tool;

FIG. 10 shows longitudinal crownings before the dressing and after the dressing; and

FIG. 11 shows a flow chart of the method according to the disclosure.

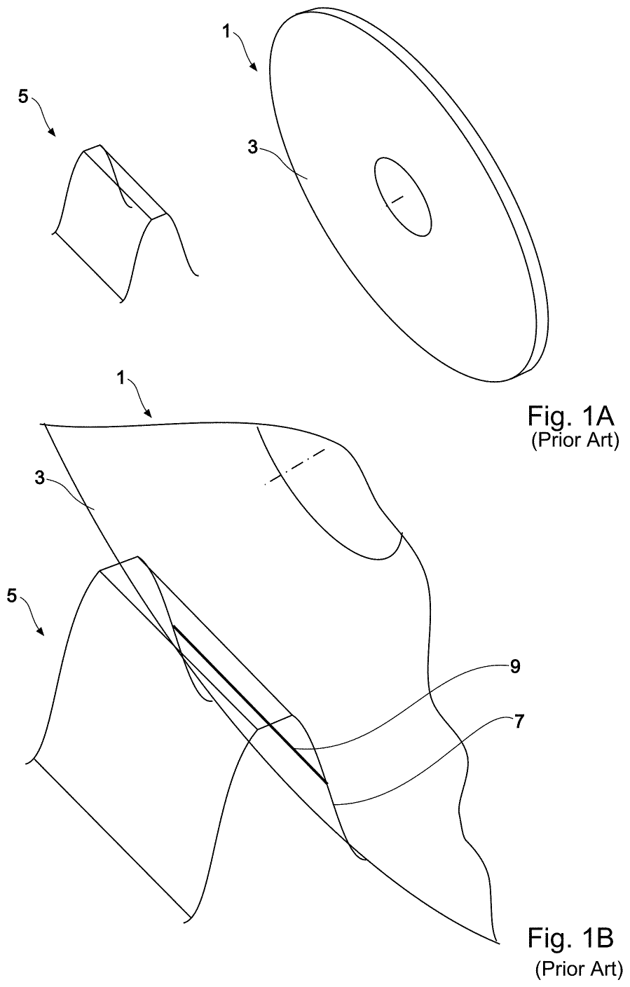

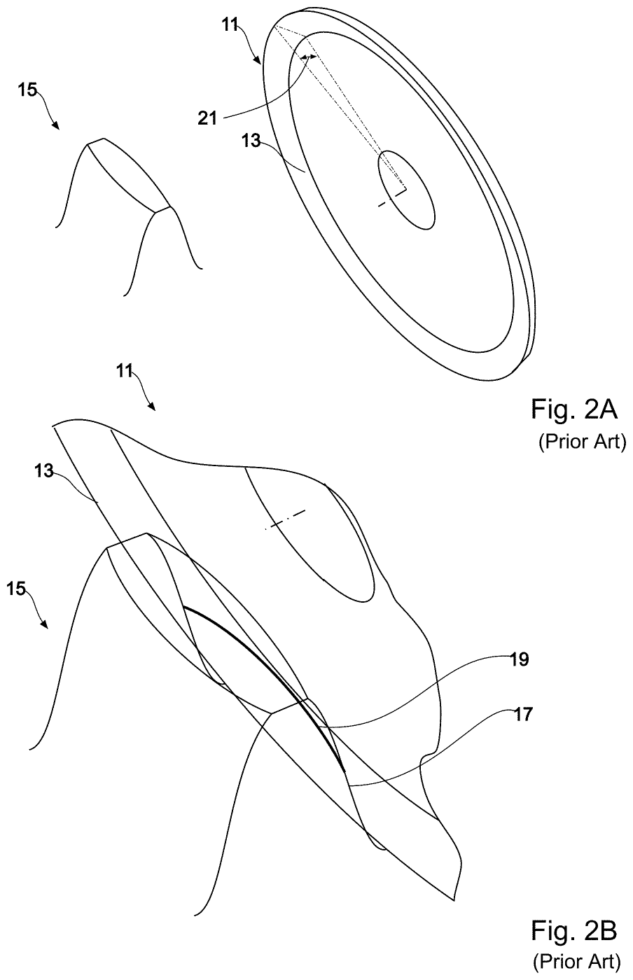

### DETAILED DESCRIPTION OF THE DRAWINGS

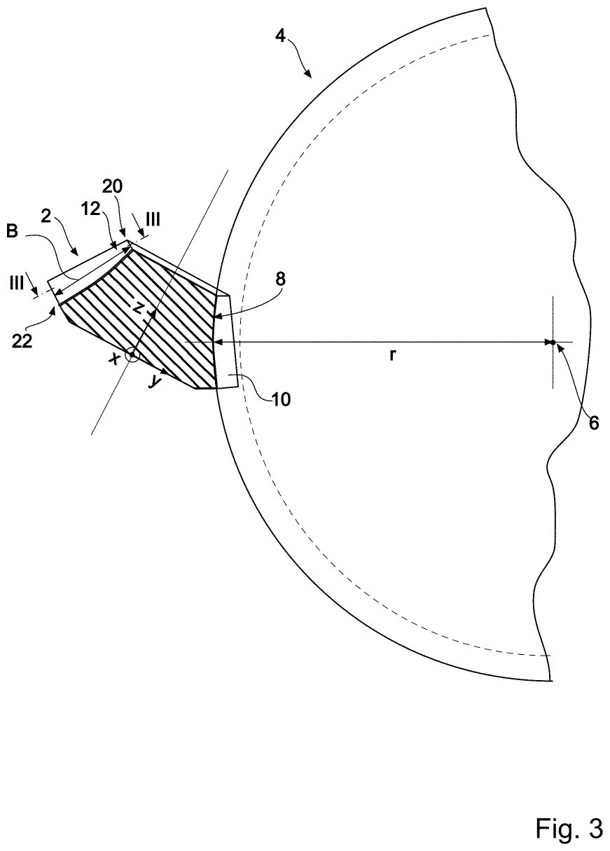

For better comprehensibility of the following explanations, a Cartesian coordinate system x-y-z is used on the workpiece in FIG. 3. It is apparent that the described dimensions and movements may also be represented in other coordinate or reference systems.

FIG. 3 shows a straight-toothed bevel gear 2 and a detail of a disk-shaped grinding tool 4. The grinding is carried out by discontinuous generating grinding. Here, for example, a workpiece rotation of the bevel gear 2 around the z axis is overlaid with a movement of the grinding tool 4, which corresponds to the movement of a tooth of a virtual generator crown gear, so that the disk-shaped grinding tool 4 and the straight-toothed bevel gear 2 roll on one another in a known manner. The grinding tool 4 rotates around a tool axis of rotation 6 during this.

Due to the grinding, a radius of curvature results in the gap base 8 of a respective tooth 10 of a straight toothing 12 of the bevel gear 4. No pendulum stroke takes place along a tooth width B. The radius of curvature in the gap base essentially corresponds to the outer radius r of the disk-shaped grinding tool 4 and remains on the finished bevel gear 2.

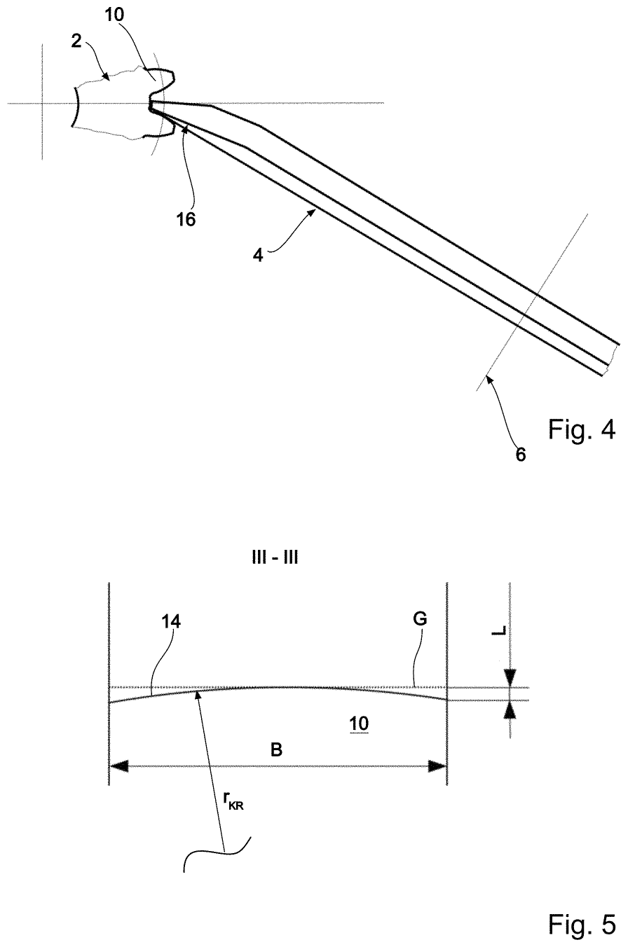

A longitudinal crowning is generated on the straight toothing 12 of the bevel gear 2 by the grinding (FIG. 4, FIG. 5). FIG. 4 shows a section in a plane which has the indicated radius r and axis 6 according to FIG. 3. The absolute value L of the longitudinal crowning is a maximum deviation of a flank line 14 of a tooth 10 from a straight line G here, as shown in FIG. 5, which schematically represents a section III-III according to FIG. 3 and shows the longitudinal crowning L along the tooth width B.

The straight line G represents by way of example here a linear, non-longitudinally-crowned flank line, for example, at the height of the pitch cone of the bevel gear 2 corresponding to section III-III. The maximum deviation is typically located in the region of a toe 20 or heel 22 of a tooth 10 (FIG. 3).

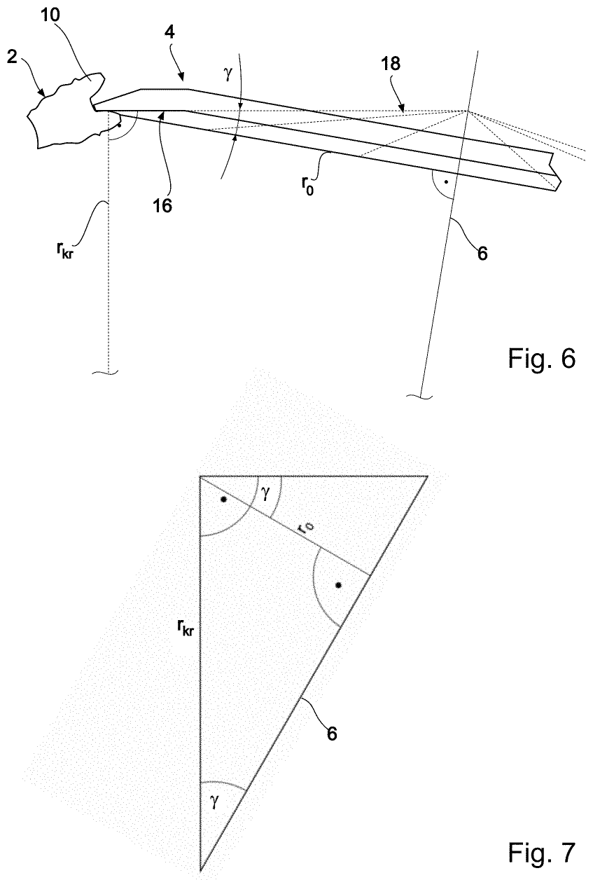

The longitudinal crowning L is generated in that a cutting face 16 of the grinding tool rotates relative to the bevel gear 2 at a hollow cone angle γ. FIG. 6 and FIG. 7 show the fundamental relationship between the hollow cone angle γ and a radius r₀ of the grinding tool 4 for a predetermined radius of curvature rₖᵣ of the longitudinal crowning. The cutting face 16 forms a section of a hollow cone inner surface 16, wherein a corresponding hollow cone 18 is indicated by the dashed lines in FIG. 6. The angles have been changed in FIG. 7 in comparison to FIG. 6 in order to shrink the sketch of FIG. 7.

The grinding tool 4 is a dressable grinding tool 4.

According to the described method, a plurality of bevel gears 2 is produced using the grinding tool 4, wherein dressing of the grinding tool 4 is carried out between the machining of the bevel gears 2. It can thus be provided that a first number of the plurality of bevel gears 2 is machined, the grinding tool 4 is then dressed, and subsequently a second number of the plurality of bevel gears 2 is machined using the dressed grinding tool 4, etc. Repeated dressing of the grinding tool 4 can thus take place during the machining of the plurality of bevel gears 2.

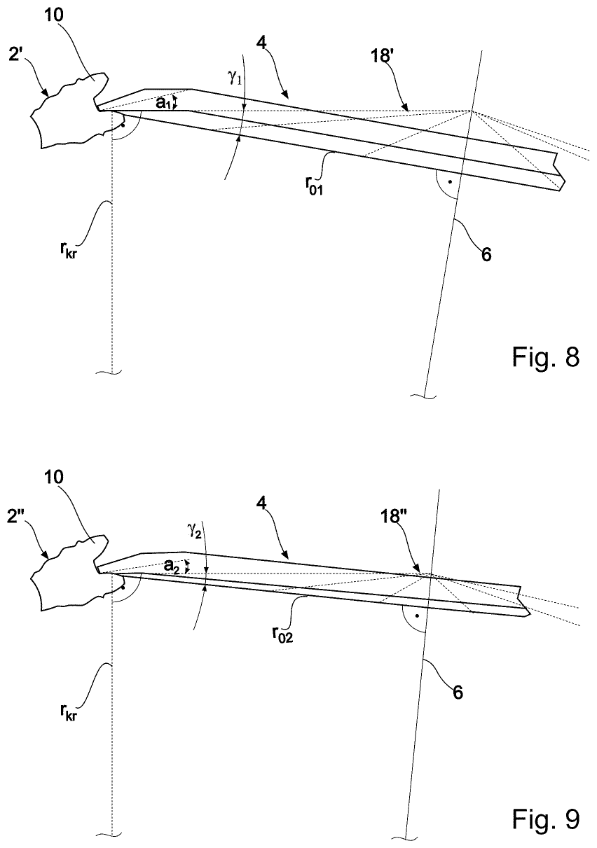

In the present case, at least one first bevel gear 2′ of the bevel gears 2 is ground before the dressing by means of the dressable grinding tool 4 and at least one second bevel gear 2″ of the bevel gears 2 is ground after the dressing by means of the dressable grinding tool 4 (FIG. 8, FIG. 9).

During the dressing of the dressable grinding tool 4, a radius of the grinding tool 4 is reduced by the dressing from a first radius r₀₁ to a second radius r₀₂.

The cutting face 16 of the grinding tool 4 forming the section of the hollow cone inner surface 16 is inclined before the dressing by a first hollow cone angle γ₁ and is inclined after the dressing by a second hollow cone angle γ2.

The radius of curvature rₖᵣ of the longitudinal crowning is constant before and after the dressing, so that essentially the same longitudinal crowning is generated before and after the dressing.

The following applies:

$${γ}_{2} = arc sin ( \frac{{r}_{02}}{{r}_{01}} \cdot sin {γ}_{1} ) ;$$

with r₀₁ as the first radius of the grinding tool, with r₀₂ as the second radius of the grinding tool, with γ₁ as the first hollow cone angle, and with γ₂ as the second hollow cone angle.

Hollow cones 18′ and 18″ are shown in each case in FIGS. 8 and 9, which each result from an extension of the cutting face 16 toward the axis of rotation 6.

To compensate for the circumstance that the radius of the grinding tool is reduced with each dressing procedure, the grinding tool 4 is therefore pivoted with decreasing radius in the direction of the bevel gear 2 in the present example, i.e., the hollow cone angle is reduced, so that essentially the same longitudinal crowning can still be produced.

Further dressing procedures can be carried out according to the same pattern, wherein hollow cone angles γ₃, γ₄, γ₅ . . . can be generated corresponding to the radii r₀₃, r₀₄, r₀₅ . . . reduced by the dressing.

A tool flank angle α₁ of the tool 4 is reduced upon dressing by the difference of the first angle of inclination γ₁ to the second angle of inclination γ₂, so that upon dressing the tool flank angle α₂ is dressed, so that before or after the dressing the same engagement angle of the bevel gear toothing is generated on the first and second bevel gear 2′, 2″.

A sequence of a method according to the disclosure thus results as follows, for example: in a first method step (a) a first bevel gear 2′ or a number of first bevel gears 2′ is machined using the grinding tool 4, wherein the grinding tool 4 has the first radius r₀₁ and the first hollow cone angle γ₁ is predetermined for generating a longitudinal crowning having a radius of curvature rₖᵣ. The grinding takes place in discontinuous generating grinding, so that the two flanks are machined in succession in sequential infeeds.

Right flanks of the respective straight toothing of a respective bevel gear 2′ are machined in a first infeed using first machine settings and left flanks of the respective straight toothing of a respective bevel gear 2′ are machined in a second infeed using second machine settings.

Subsequently, in method step (b), dressing of the grinding tool 4 takes place, wherein the dressing takes place in such a way that after the dressing in a method step (c), a second bevel gear 2″ or a number of second bevel gears 2″ is generated using the dressed grinding tool 4, the longitudinal crowning of which after the dressing essentially corresponds to the longitudinal crowning before the dressing.

For this purpose, in the design of the dressing procedure, the radius of curvature rₖᵣ is specified as constant and the hollow cone angle γ₂ is adapted in accordance with the reduced radius r₀₂, using the above-mentioned rule

$${γ}_{2} = arc sin ( \frac{{r}_{02}}{{r}_{01}} \cdot sin {γ}_{1} ) .$$

The absolute value L of a longitudinal crowning of the straight toothing of the first bevel gear 2′ generated by the grinding corresponds to the absolute value of the longitudinal crowning of the straight toothing of the second bevel gear 2″ generated by the grinding.

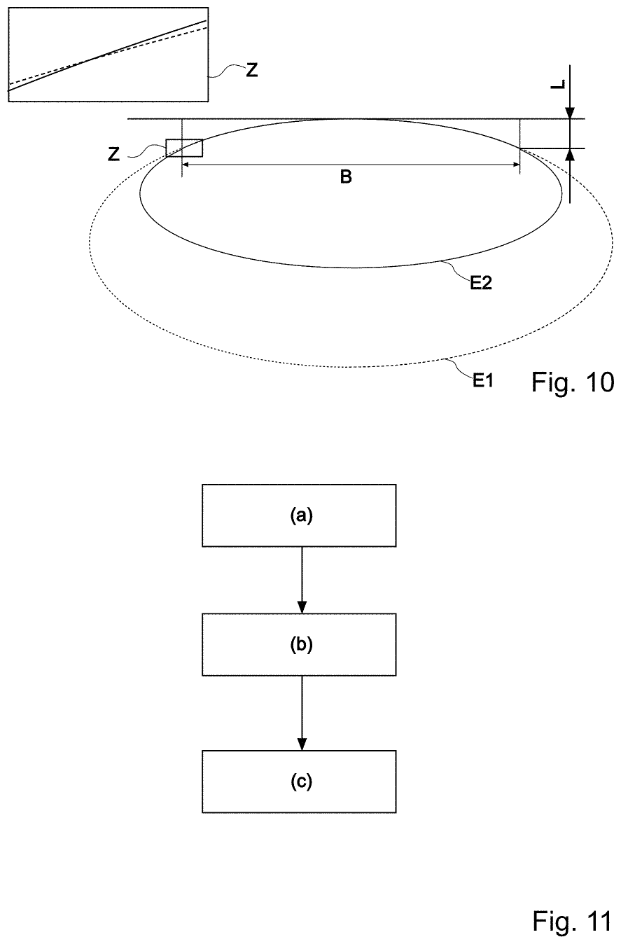

The shape of the longitudinal crowning of the first bevel gear can deviate from the shape of the longitudinal crowning of the second bevel gear. This is illustrated in FIG. 10. Before the dressing, a point of the cutting face 16 moves in relation to the tooth flank to be ground, for example, along the ellipse E1 and after the dressing along the ellipse E2.

The same longitudinal crowning results according to absolute value, since the maximum distance along the tooth width B is L in both cases. The shape of the flank line deviates minimally from one another, however, as the detail Z shows in magnified form. This deviation, which can be mathematically computed, typically moves in the low single-digit micrometer range or is less than 1 micrometer, so that this deviation is negligible against the background of typical manufacturing tolerances.

1. A method having the following steps:
grinding of bevel gears,
wherein the respective bevel gears have a straight toothing to be ground,
wherein the grinding is carried out with a disk-shaped grinding tool by discontinuous generating grinding using a predetermined rolling ratio,
wherein a grinding face of the grinding tool, which rolls during the grinding with teeth of the straight toothing of a respective bevel gear, forms a section of a hollow cone inner surface, and
wherein a respective longitudinal crowning is generated on the respective straight toothing of the respective bevel gears by the grinding using the cutting face forming the section of the hollow cone inner surface,
wherein the grinding tool is a dressable grinding tool and dressing of the grinding tool is carried out,
wherein at least one first bevel gear of the bevel gears is ground before the dressing by the dressable grinding tool and
wherein at least one second bevel gear of the bevel gears is ground after the dressing by the dressable grinding tool,
wherein during the dressing of the dressable grinding tool, a radius of the grinding tool is reduced by the dressing from a first radius (r₀₁) to a second radius (r₀₂),
wherein the cutting face of the grinding tool forming the section of the hollow cone inner surface is inclined before the dressing by a first hollow cone angle (γ₁) and is inclined after the dressing by a second hollow cone angle (γ₂),
wherein a radius of curvature (rₖᵣ) of the longitudinal crowning is constant before and after the dressing, and
wherein the following applies:
γ₂=arcsin(r₀₂/r₀₁·sin γ₁);
with r₀₁ as the first radius of the grinding tool,
with r₀₂ as the second radius of the grinding tool,
with γ₁ as the first hollow cone angle, and
with γ₂ as the second hollow cone angle.

2. The method according to claim 1,
wherein
the absolute value (L) of a longitudinal crowning of the straight toothing of the first bevel gear generated by the grinding corresponds to the absolute value (L) of a longitudinal crowning of the straight toothing of the second bevel gear generated by the grinding.

3. The method according to claim 1,
wherein
a radius of curvature in a gap base of the straight toothing of the first bevel gear is greater than a radius of curvature in a gap base of the straight toothing of the second bevel gear.

4. The method according to claim 1,
wherein
the shape of the longitudinal crowning of the first bevel gear deviates from the shape of the longitudinal crowning of the second bevel gear.

5. The method according to claim 1,
wherein
a tool flank angle (α₁, α₂) of the grinding tool is adapted by the dressing and/or after the dressing, the predetermined rolling ratio between the grinding tool and the second bevel gear is adapted,
wherein before and after the dressing, the same engagement angle is generated on the first and second bevel gear.

6. The method according to claim 1,
wherein
a tool flank angle (α₁, α₂) of the grinding tool is adapted by the dressing by the difference of the first angle of inclination (γ₁) to the second angle of inclination (γ₂),
wherein before and after the dressing, the same engagement angle is generated on the first and second bevel gear.

7. The method according to claim 1,
wherein
right flanks of the respective straight toothing of a respective bevel gear are machined in a first infeed using first machine settings, and
left flanks of the respective straight toothing of a respective bevel gear are machined in a second infeed using second machine settings.

8. The method according to claim 1,
wherein
no relative stroke movement takes place between the bevel gear and the grinding tool along a tooth width.
